(19) United States
(12) Patent Application Publication
(10) Pub. No.: US 2026/0312517 A1
(43) Pub. Date: Oct. 8, 2026

(54) Data-Driven Predictive Current Modeling Method, Apparatus, Medium, and Device for a Permanent Magnet Synchronous Motor

(71) Applicant: SOUTHWEST JIAOTONG UNIVERSITY, Chengdu (CN)

(72) Inventors: Chenwei MA, Chengdu (CN); Zichun TANG, Chengdu (CN); Wensheng SONG, Chengdu (CN); Xinglai GE, Chengdu (CN); Cheng XUE, Chengdu (CN); Jian CHEN, Chengdu (CN)

(21) Appl. No.: 19/699,911

(22) Filed: Jun. 5, 2026

Related U.S. Application Data
(63) Continuation of application No. PCT/CN2025/138134, filed on Nov. 27, 2025.

(30) Foreign Application Priority Data
Dec. 9, 2024 (CN) 202411794611.8

(51) Int. Cl. H02P 21/14; H02P 21/00; H02P 21/22

(52) U.S. Cl. CPC H02P 21/14; H02P 21/0003; H02P 21/22; H02P 2207/05

(57) ABSTRACT

Embodiments of the present application disclose a data-driven predictive current modeling method, apparatus, medium, and device for a permanent magnet synchronous motor, and relate to the technical field of converters. The present application is intended to address the problem in the prior art that a predictive current model is susceptible to noise interference, resulting in reduced prediction accuracy. In the present application, a data-driven current prediction model for a motor is first obtained by taking into account the influence of a cross-saturation effect on electromagnetics under actual operating conditions. A ridge-regression-based calculation model for a parameter vector in the model is then constructed based on historical data. Further, by evaluating a severity level of noise in the data, dynamic adjustment of a ridge parameter is established to achieve adaptive penalization of the data noise.

### TECHNICAL FIELD

The present application relates to the technical field of converters, and in particular to a data-driven predictive current modeling method, apparatus, medium, and device for a permanent magnet synchronous motor.

### BACKGROUND

Model predictive control (MPC) has attracted extensive attention in the field of motor drives due to advantages such as fast dynamic response and strong control flexibility, and is regarded as a promising alternative to conventional control methods. Conventional MPC predicts system behavior based on a motor model, which means that the controller requires accurate motor parameters to achieve satisfactory control performance. However, under actual operating conditions, key motor parameters are highly sensitive. Accordingly, data-driven technologies have attracted increasing attention in addressing the parameter dependency issue of MPC.

Among these, least squares (LS) has been demonstrated to be a potential alternative to conventional MPC. The basic principle of least squares is to find an optimal estimate of model parameters by minimizing a sum of squares of errors between predicted values and actual values. The core idea is to cause predicted results of the model to match observed data as closely as possible. Therefore, this data-based solution can identify a more accurate current prediction model in real time, thereby improving predictive control performance. Due to potential noise in current sensor measurements, however, the dependence of the least-squares method on system input and output data presents challenges. Under noise interference, a predictive current model established by least squares is susceptible to interference, resulting in poor current prediction accuracy and thereby affecting control performance.

### SUMMARY

A main objective of the present application is to provide a data-driven predictive current modeling method, apparatus, medium, and device for a permanent magnet synchronous motor, so as to address the problem in the prior art that predictive current models are susceptible to noise interference, resulting in reduced prediction accuracy.

To achieve the above objective, embodiments of the present application adopt the following technical solutions.

In a first aspect, an embodiment of the present application provides a data-driven predictive current modeling method for a permanent magnet synchronous motor, the method comprising the following steps:
obtaining a data-driven current prediction model, based on a cross-saturation effect, for a target motor, wherein the data-driven current prediction model comprises a parameter vector;
establishing, based on historical data collected in historical control cycles, a ridge-regression-based calculation model of the parameter vector, wherein the calculation model comprises a penalty term;
determining a target solution of the penalty term based on a noise severity of the historical data; and
obtaining, based on the target solution, a target penalty term and a target parameter vector so as to establish a target data-driven current prediction model.

In one possible implementation of the first aspect, before determining the target solution of the penalty term based on the noise severity of the historical data, the method further comprises:
respectively constructing matrices from data in the historical data corresponding to input data and output data;
obtaining a sum of squared residuals and a total sum of squares based on the matrices; and
obtaining multicollinearity of the input data based on the sum of squared residuals and the total sum of squares so as to characterize the noise severity of the historical data.

In one possible implementation of the first aspect, determining the target solution of the penalty term based on the noise severity of the historical data comprises:
obtaining, based on a positive correlation relationship between the multicollinearity and the noise severity of the historical data, a relationship between the multicollinearity and the penalty term; and
mapping, based on a mapping function, the relationship between the multicollinearity and the penalty term, and determining the target solution of the penalty term.

In one possible implementation of the first aspect, obtaining the multicollinearity of the input data based on the sum of squared residuals and the total sum of squares so as to characterize the noise severity of the historical data comprises:
obtaining, based on the sum of squared residuals and the total sum of squares, a variance inflation factor of the input data to measure the multicollinearity of the input data so as to characterize the noise severity of the historical data.

In one possible implementation of the first aspect, before obtaining the data-driven current prediction model, based on a cross-saturation effect, for the target motor, the method further comprises:
obtaining the input data and the output data, respectively, based on a stator voltage and a stator current in current control of the target motor; and
establishing the data-driven current prediction model, based on a cross-saturation effect, for the target motor based on the input data, the output data, and the parameter vector.

In one possible implementation of the first aspect, establishing the ridge-regression-based calculation model of the parameter vector based on the historical data collected in the historical control cycles comprises:
obtaining historical input data and historical output data based on the historical data collected in the historical control cycles;
respectively constructing a past subset and a future subset based on the historical input data and the historical output data; and
establishing the ridge-regression-based calculation model of the parameter vector based on the past subset and the future subset.

In one possible implementation of the first aspect, establishing the ridge-regression-based calculation model of the parameter vector based on the past subset and the future subset comprises:

estimating the parameter vector based on the past subset and the future subset using a least-squares solution so as to establish the ridge-regression-based calculation model of the parameter vector.

In a second aspect, an embodiment of the present application provides a data-driven predictive current modeling apparatus for a permanent magnet synchronous motor, comprising:
an obtaining module configured to obtain, for a target motor, a data-driven current prediction model based on a cross-saturation effect, wherein the data-driven current prediction model comprises a parameter vector;
an establishing module configured to establish, based on historical data collected in historical control cycles, a ridge-regression-based calculation model of the parameter vector, wherein the calculation model comprises a penalty term;
a determining module configured to determine a target solution of the penalty term based on a noise severity of the historical data; and
a target module configured to obtain, based on the target solution, a target penalty term and a target parameter vector so as to establish a target data-driven current prediction model.

In a third aspect, an embodiment of the present application provides a computer-readable storage medium storing a computer program, wherein, when the computer program is loaded and executed by a processor, the computer program implements the data-driven predictive current modeling method for a permanent magnet synchronous motor according to any one of the implementations of the first aspect described above.

In a fourth aspect, an embodiment of the present application provides an electronic device, comprising a processor and a memory, wherein:
the memory is configured to store a computer program; and
the processor is configured to load and execute the computer program so that the electronic device performs the data-driven predictive current modeling method for a permanent magnet synchronous motor according to any one of the implementations of the first aspect described above.

Compared with the prior art, the beneficial effects of the present application are as follows:

Embodiments of the present application provide a data-driven predictive current modeling method, apparatus, medium, and device for a permanent magnet synchronous motor. The method comprises: obtaining, for a target motor, a data-driven current prediction model based on a cross-saturation effect, wherein the data-driven current prediction model comprises a parameter vector; establishing, based on historical data collected in historical control cycles, a ridge-regression-based calculation model of the parameter vector, wherein the calculation model comprises a penalty term; determining a target solution of the penalty term based on a noise severity of the historical data; and obtaining, based on the target solution, a target penalty term and a target parameter vector so as to establish a target data-driven current prediction model. In the present application, a data-driven current prediction model of a motor is first obtained in consideration of an influence of a cross-saturation effect on electromagnetics under actual conditions. Then, a ridge-regression-based calculation model of a parameter vector in the model is constructed based on historical data. Further, by evaluating a severity of noise in the data, dynamic adjustment of a ridge parameter is established to achieve adaptive penalization of the data noise, a target solution of a penalty term is determined, and the parameter vector is further back-calculated to obtain a final prediction model, thereby improving current prediction accuracy under noisy operating conditions.

### BRIEF DESCRIPTION OF THE DRAWINGS

FIG. 1 is a schematic diagram showing overfitting of least squares caused by noise;

FIG. 2 is a schematic diagram showing fitting by ridge regression;

FIG. 3 is a schematic diagram showing an optimal solution space of ridge regression;

FIG. 4 is a schematic structural diagram of an electronic device in a hardware operating environment involved in embodiments of the present application;

FIG. 5 is a schematic flowchart of a data-driven predictive current modeling method for a permanent magnet synchronous motor according to embodiments of the present application;

FIG. 6 is a schematic diagram showing a comparison of waveforms of d-q axis predicted currents, d-q axis actual currents, and d-q axis predicted current residuals based on least squares;

FIG. 7 is a schematic diagram showing a comparison of waveforms of d-q axis predicted currents, d-q axis actual currents, and d-q axis predicted current residuals according to the data-driven predictive current modeling method for a permanent magnet synchronous motor provided in embodiments of the present application;

FIG. 8 is a schematic diagram showing a comparison of waveforms of rotational speed, d-q axis actual currents, and phase-A current based on least squares;

FIG. 9 is a schematic diagram showing a comparison of waveforms of rotational speed, d-q axis actual currents, and phase-A current according to the data-driven predictive current modeling method for a permanent magnet synchronous motor provided in embodiments of the present application;

FIG. 10 is a schematic module diagram of a data-driven predictive current modeling apparatus for a permanent magnet synchronous motor provided in embodiments of the present application.

In the drawings: 101—processor, 102—communication bus, 103—network interface, 104—user interface, and 105—memory.

### DETAILED DESCRIPTION

It should be understood that the specific embodiments described herein are merely used to explain the present application and are not intended to limit the present application.

A main solution provided in embodiments of the present application is as follows: obtaining, for a target motor, a data-driven current prediction model based on a cross-saturation effect, wherein the data-driven current prediction model comprises a parameter vector; establishing, based on historical data collected in historical control cycles, a ridge-regression-based calculation model of the parameter vector, wherein the calculation model comprises a penalty term; determining a target solution of the penalty term based on a noise severity of the historical data; and obtaining, based on the target solution, a target penalty term and a target parameter vector so as to establish a target data-driven current prediction model.

Model predictive control (MPC) has attracted extensive attention in the field of motor drives due to advantages such as fast dynamic response and strong control flexibility, and is regarded as a promising alternative to conventional control methods, such as field-oriented control and direct torque control. Conventional MPC predicts system behavior based on a motor model, which means that a controller requires accurate motor parameters to achieve satisfactory control performance. However, under actual operating conditions, key motor parameters are highly sensitive. For example, a resistance of a permanent magnet synchronous motor (PMSM) may vary with temperature changes, and an inductance value may also be affected by magnet saturation and a cross-saturation effect. In practical applications, such disturbances make accurate motor modeling and accurate acquisition of motor parameters difficult. Therefore, conventional MPC based on fixed motor parameters suffers from a parameter mismatch problem, resulting in degraded performance.

Against a background centered on digitalization, networking, and intelligence, data-driven technologies have attracted extensive attention because of a concept of deeply integrating a new generation of information technologies with mathematical models, thereby providing an effective solution for modeling strongly coupled time-varying systems. Among these technologies, least-squares techniques have been widely applied in system identification and intelligent control to predict and explain relationships among variables. In general, various solutions have been proposed to improve parameter robustness of MPC for PMSM drives, among which least squares (LS) has been demonstrated to be a potential alternative to conventional MPC. The basic principle of least squares is to find an optimal estimate of model parameters by minimizing a sum of squares of errors between predicted values and actual values. The core idea is to cause predicted results of a model to match observed data as closely as possible. Therefore, this data-based solution can identify a more accurate current prediction model in real time, thereby improving predictive control performance.

Anti-interference performance is a key issue faced by data-driven technologies. Due to potential noise in current sensor measurements, the dependence of the least-squares method on system input and output data presents challenges. Sources of noise are diverse and include manufacturing errors, temperature variations, and sensor aging. On the other hand, electromagnetic fields in a motor operating environment may interfere with transmission of signals, resulting in noise in sampled signals. Such interference may originate from electromagnetic emission of the motor itself or from electromagnetic interference caused by other devices. In many industrial applications, motors often operate in environments with significant electromagnetic noise, and the electromagnetic noise readily couples with sampled signals, causing persistent measurement errors and affecting model performance. Therefore, in order to ensure robustness of a control system, uncertainty in observed data in the least-squares method must be taken into account.

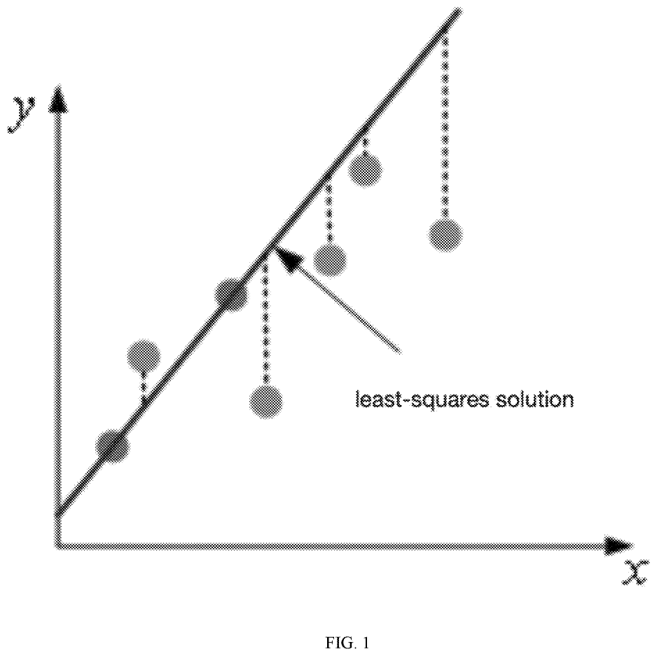

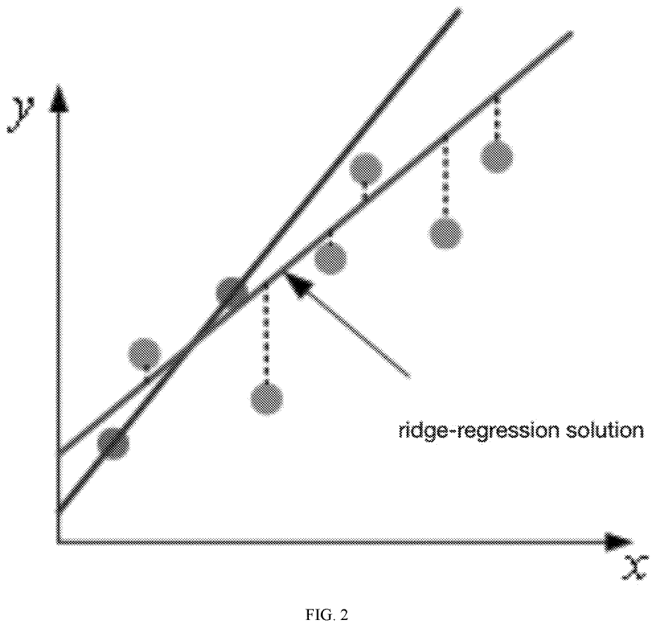

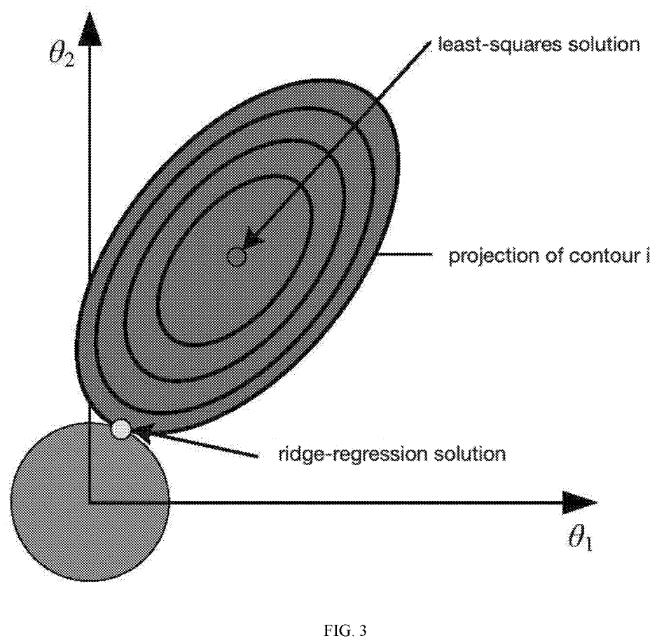

As shown in FIG. 1, noise may cause overfitting in least squares. In embodiments of the present application, ridge regression is applied to the field of permanent magnet synchronous motor drives. FIG. 2 is a schematic diagram showing fitting by ridge regression, and FIG. 3 is a schematic diagram showing an optimal solution space of ridge regression. By evaluating a severity of noise and applying dynamic adjustment of a ridge coefficient, adaptive penalization of data noise is achieved, thereby improving robustness.

Accordingly, the present application provides a solution in which a data-driven current prediction model of a motor is first obtained in consideration of an influence of a cross-saturation effect on electromagnetics under actual conditions. Then, a ridge-regression-based calculation model of a parameter vector in the model is constructed based on historical data. Further, by evaluating a severity of noise in the data, dynamic adjustment of a ridge parameter is established to achieve adaptive penalization of the data noise, a target solution of a penalty term is determined, and the parameter vector is further back-calculated to obtain a final prediction model, thereby improving current prediction accuracy under noisy operating conditions.

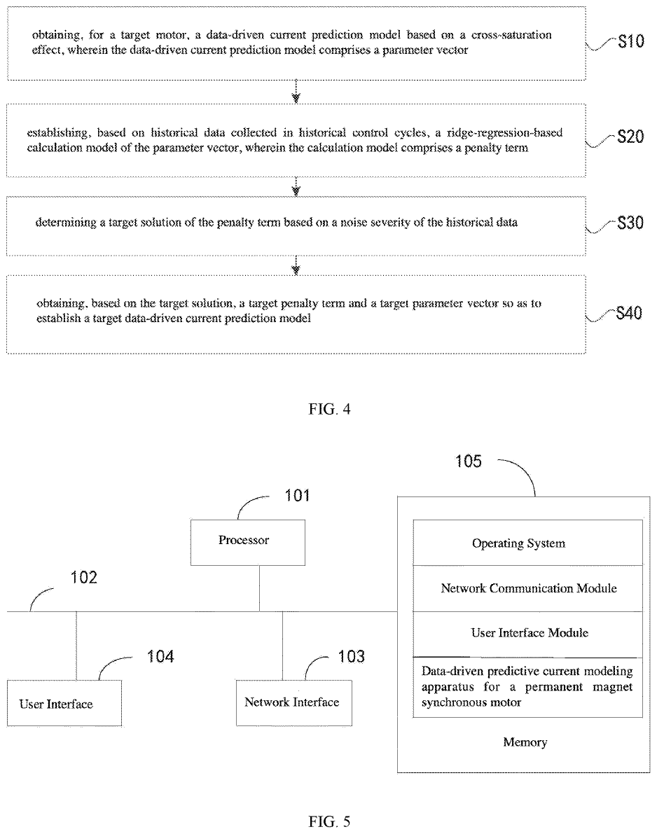

Referring to FIG. 4, FIG. 4 is a schematic structural diagram of an electronic device in a hardware operating environment involved in embodiments of the present application. The electronic device may include a processor 101, such as a central processing unit (CPU), a communication bus 102, a user interface 104, a network interface 103, and a memory 105. The communication bus 102 is used to implement connection and communication among these components. The user interface 104 may include a display and an input unit such as a keyboard. Optionally, the user interface 104 may further include a standard wired interface and a wireless interface. Optionally, the network interface 103 may include a standard wired interface and a wireless interface, such as a wireless fidelity (Wi-Fi) interface. The memory 105 may optionally be a storage device independent of the processor 101 described above. The memory 105 may be a high-speed random access memory (RAM), or may be a stable non-volatile memory (NVM), such as at least one disk memory. The processor 101 may be a general-purpose processor, including a central processor and a network processor, and may also be a digital signal processor, an application-specific integrated circuit, a field programmable gate array, another programmable logic device, a discrete gate or transistor logic device, or a discrete hardware component.

A person skilled in the art will understand that the structure shown in FIG. 4 does not constitute a limitation on the electronic device, and the electronic device may include more or fewer components than those shown, may combine certain components, or may have a different arrangement of components.

As shown in FIG. 4, the memory 105, serving as a storage medium, may include an operating system, a network communication module, a user interface module, and a data-driven predictive current modeling apparatus for a permanent magnet synchronous motor.

In the electronic device shown in FIG. 4, the network interface 103 is mainly used for data communication with a network server, and the user interface 104 is mainly used for data interaction with a user. In the present application, the processor 101 and the memory 105 may be provided in the electronic device. The electronic device invokes, through the processor 101, the data-driven predictive current modeling apparatus for a permanent magnet synchronous motor stored in the memory 105, and executes the data-driven predictive current modeling method for a permanent magnet synchronous motor provided in embodiments of the present application.

Referring to FIG. 5, based on the hardware device in the foregoing embodiments, embodiments of the present application provide a data-driven predictive current modeling method for a permanent magnet synchronous motor, including the following steps.

S10: obtaining, for a target motor, a data-driven current prediction model based on a cross-saturation effect, wherein the data-driven current prediction model comprises a parameter vector.

In a specific implementation process, the target motor is a motor for which a data-driven current prediction model is to be established, and is a permanent magnet synchronous motor. Cross saturation means that magnetic flux is unevenly distributed in a magnetic circuit of the motor, causing some magnetic flux paths to simultaneously reach a magnetic saturation state while other paths do not reach the saturation state. Data-driven refers to a process of using collected, analyzed, and interpreted data to guide decision-making, optimize processes, and achieve objectives.

In one embodiment, before obtaining, for the target motor, the data-driven current prediction model based on a cross-saturation effect, the method further comprises:
obtaining input data and output data, respectively, based on a stator voltage and a stator current in current control of the target motor; and
establishing, based on the input data, the output data, and the parameter vector, the data-driven current prediction model for the target motor based on a cross-saturation effect.

In a specific implementation process, in current control of a permanent magnet synchronous motor, the stator voltage and the stator current are respectively an input and an output of the system, and a state-space representation taking the cross-saturation effect into account is:

$$y ( k + 1 ) = θ x ( k + 1 )$$

$$x ( k + 1 ) = [ \begin{matrix}\begin{matrix}y ( k ) \\ u ( k )\end{matrix} \\ 1\end{matrix} ] , θ = [ \begin{matrix}{a}_{11} & {a}_{21} & {b}_{11} & {b}_{21} & {e}_{1} \\ {a}_{12} & {a}_{22} & {b}_{12} & {b}_{22} & {e}_{2}\end{matrix} ]$$

where k is a sampling instant, x is a regression matrix, u=[u_{d}, u_{q}]^{T} is a system input voltage, y=[i_{d}, i_{q}]^{T} is a system output current, θ is the parameter vector, and a, b, and e are elements in the parameter vector and respectively correspond to coefficients of a current term, a voltage term, and a constant term on dq axes.

S20: establishing, based on historical data collected in historical control cycles, a ridge-regression-based calculation model of the parameter vector, wherein the calculation model comprises a penalty term.

In a specific implementation process, the parameter vector is estimated based on historical data collected over multiple previous control cycles. In a predictive current control environment of a PMSM drive, dq axis voltages applied in each control cycle are determined by a controller and are therefore stored as input data. On the other hand, dq axis currents sampled at the beginning of each control cycle are stored as output data. That is, the historical data are divided into historical input data and historical output data. Establishing the ridge-regression-based calculation model of the parameter vector based on the historical data collected in the historical control cycles comprises:
obtaining historical input data and historical output data based on the historical data collected in the historical control cycles;
respectively constructing a past subset and a future subset based on the historical input data and the historical output data; and
establishing the ridge-regression-based calculation model of the parameter vector based on the past subset and the future subset.

In a specific implementation process, datasets of the historical input data and the historical output data are denoted as U_ds and Y_ds, respectively. A set of subsets may be constructed, and two past subsets and two future subsets are defined for the input data and the output data as follows:

$${U}_{p} = [ \begin{matrix}{u}_{1} & {u}_{2} & … & {u}_{N - 1}\end{matrix} ]$$

$${U}_{f} = [ \begin{matrix}{u}_{2} & {u}_{3} & … & {u}_{N}\end{matrix} ]$$

$${Y}_{p} = [ \begin{matrix}{y}_{1} & {y}_{2} & … & {y}_{N - 1}\end{matrix} ]$$

$${Y}_{f} = [ \begin{matrix}{y}_{2} & {y}_{3} & … & {y}_{N}\end{matrix} ]$$

The subscripts p and f represent past and future, respectively. U_p is a past subset of the historical input data, U_{f} is a future subset of the historical input data, Yₚ is a past subset of the historical output data, and Y_{f} is a future subset of the historical output data. The number of columns of each of these matrices is N−1. At the sampling instant k, a calculation formula for the ridge-regression parameter vector θ, that is, the calculation model, may be established based on the collected data.

$$θ = {Y}_{f} {{H}^{T} ( {HH}^{T} + λ I )}^{- 1}$$

$$where H = [ \begin{matrix}{Y}_{p} \\ {U}_{f} \\ 1\end{matrix} ]$$

I is an identity matrix, and H^{T} is a transpose of H. If HH^{T} is a singular matrix, an added λI term can ensure that HH^{T}+λI is full-rank, so that the matrix is invertible while suppressing an influence of noise.

In one embodiment, establishing the ridge-regression-based calculation model of the parameter vector based on the past subset and the future subset comprises:
estimating the parameter vector based on the past subset and the future subset using a least-squares solution so as to establish the ridge-regression-based calculation model of the parameter vector.

In a specific implementation process, the parameter vector is estimated using the least-squares solution based on the constructed past subset and future subset. In general, a least-squares objective is to achieve global fitting optimization, and can provide an accurate unbiased estimate in the absence of noise. However, data are not always ideal in practical applications. In a permanent magnet synchronous motor drive, current sensing generates measurement noise, and under certain low-speed and low-load conditions, such noise effects become more pronounced. In this case, data noise causes a multicollinearity problem. A conventional least-squares method may lead to unreliable results because of overfitting. Therefore, sensitivity of least squares to noisy data reduces current prediction accuracy of the PMSM drive. Ridge regression is introduced to solve the foregoing multicollinearity problem. By adding a regularization term to a loss function, the problem of high correlation among independent variables is addressed, so that predictive performance of the model becomes more stable.

In conventional LS regression, a loss function J is defined as:

$$J ( θ ) = {‖ {Y}_{f} - θ H ‖}^{2}$$

In the ridge regression model, an L2-norm penalty term is added to the loss function to solve the multicollinearity problem:

$$J ( θ ) = {‖ {Y}_{f} - θ H ‖}^{2} + λ \vert \vert {θ}^{2}$$

where λ∈[0, ∞] is a ridge coefficient for adjusting the penalty. A main idea of ridge regression is to add an additional penalty term to the loss function of conventional LS, thereby reducing the optimal solution space. The above equation may be further written as:

$$\begin{matrix}J ( θ ) = {( {Y}_{f} - θ H )}^{T} ( {Y}_{f} - θ H ) + λ {θ}^{T} θ \\ = {Y}_{f}^{T} {Y}_{f} - {Y}_{f}^{T} θ H - {H}^{T} {θ}^{T} {Y}_{f} + {H}^{T} {θ}^{T} θ H + λ {θ}^{T} θ\end{matrix}$$

In order to minimize J(θ), a minimum point is found by applying the following relation ∂J(θ)/∂θ=0, and the following relationship may then be derived:

$$0 - {H}^{T} {Y}_{f} - {H}^{T} Y + 2 H {H}^{T} θ + 2 λ θ = 0$$

Accordingly, the parameter vector under ridge regression may be expressed as:

$$θ = {Y}_{f} {{H}^{T} ( {HH}^{T} + λ I )}^{- 1}$$

S30: determining a target solution of the penalty term based on a noise severity of the historical data.

In a specific implementation process, by establishing the prediction model, a final solution of the model is converted into a final solution of the parameter vector, and is further adjusted according to the noise severity so that the final solution of the model is converted into a target solution of the penalty term. Specifically, determining the target solution of the penalty term based on the noise severity of the historical data comprises:
obtaining, based on a positive correlation relationship between the multicollinearity and the noise severity of the historical data, a relationship between the multicollinearity and the penalty term; and
mapping, based on a mapping function, the relationship between the multicollinearity and the penalty term, and determining the target solution of the penalty term.

In a specific implementation process, a ridge coefficient is introduced to compensate for multicollinearity caused by data noise. Since the multicollinearity is positively correlated with the noise severity of the data, a larger λ should be used as the multicollinearity becomes greater so as to increase penalty strength. Therefore, a relationship between the penalty strength λ and a severity of multicollinearity VIF_iq may be mapped by using a sigmoid function. Accordingly, an optimal λ, that is, the target solution of the penalty term, may be obtained online according to an evaluation result of the data noise, and the relationship is given as follows:

$$λ = \frac{α}{1 + {e}^{- ( {VIF}_{iq} + β )}}$$

where e is a natural constant, and α and β are fixed coefficients used to horizontally and vertically stretch the sigmoid function. Optimal values of α and β may be searched through offline cross-validation of experimental data, so as to skip an undesired penalty range corresponding to a relatively low severity of multicollinearity and limit the penalty strength to an appropriate range.

In one embodiment, before determining the target solution of the penalty term based on the noise severity of the historical data, the method further comprises:
respectively constructing matrices from data in the historical data corresponding to input data and output data;
obtaining a sum of squared residuals and a total sum of squares based on the matrices; and
obtaining multicollinearity of the input data based on the sum of squared residuals and the total sum of squares so as to characterize the noise severity of the historical data.

In a specific implementation process, in the data-driven current prediction model, elements involved in the input voltage and the output current include i_{d}, i_{q}, u_{d}, and u_{q}. Data corresponding to each variable are collected into a matrix, which may be represented as X. Accordingly, a regression coefficient b of i_{q} may be calculated as:

$$b = ( {X}_{no \_ iq} {X}_{no \_ iq}^{T} ) / ( {X}_{no \_ iq} {X}_{iq}^{T} )$$

where X_{iq} is a row of X containing i_{q} data, X_{no_iq} is a remaining row of X that does not contain i_{q} data, and

$${X}_{iq}^{T} and {X}_{no \_ iq}^{T}$$

are transposes of X_{iq} and X_{no_iq}, respectively. A correlation coefficient between i_{q} and other variables may thus be obtained. The sum of squared residuals SSR may be expressed as:

$$SSR = \sum {( {X}_{no \_ iq}^{T} b - {\overline{X}}_{iq}^{T} )}^{2}$$

where

$${\overline{X}}_{iq}^{T}$$

is an average value of the

$${X}_{iq}^{T}$$

data. The total sum of squares SST may be expressed as:

$$SST = \sum {( {X}_{iq}^{T} - {\overline{X}}_{iq}^{T} )}^{2}$$

Accordingly, a variance inflation factor VIF of i_{q} may be expressed as:

$${VIF}_{i q} = \frac{1}{1 - {R}^{2}}$$

$$where {R}^{2} = SSR / SST .$$

The VIF value represents a severity of multicollinearity related to data noise. That is, obtaining multicollinearity of the input data based on the sum of squared residuals and the total sum of squares so as to characterize the noise severity of the historical data comprises:

obtaining, based on the sum of squared residuals and the total sum of squares, a variance inflation factor of the input data to measure the multicollinearity of the input data so as to characterize the noise severity of the historical data.

When the VIF exceeds a threshold, conventional LS regression becomes unreliable. Ridge regression is introduced to improve prediction accuracy. In embodiments of the present application, an average value of the VIF is used to evaluate the noise severity of the data.

S40: obtaining, based on the target solution, a target penalty term and a target parameter vector so as to establish a target data-driven current prediction model.

In a specific implementation process, according to the foregoing steps, by determining the target solution of the penalty term, the penalty term may be determined and a target solution of the parameter vector, namely the target parameter vector, may be further back-calculated. The parameter vector in the initially established model is then updated to obtain the final target data-driven current prediction model.

In this embodiment, a data-driven current prediction model of a motor is first obtained in consideration of an influence of a cross-saturation effect on electromagnetics under actual conditions. Then, a ridge-regression-based calculation model of a parameter vector in the model is constructed based on historical data. Further, by evaluating a severity of noise in the data, dynamic adjustment of a ridge parameter is established to achieve adaptive penalization of the data noise, a target solution of a penalty term is determined, and the parameter vector is further back-calculated to obtain a final prediction model, thereby improving current prediction accuracy under noisy operating conditions.

In order to verify effectiveness of the method provided in embodiments of the present application, ridge regression and least squares are compared under different noise levels. A comparison of d-q axis predicted current residuals is shown in Table 1.

TABLE 1
Comparison of variances of prediction residuals
at a rotational speed of 300 rpm

| | | | | Method of |
|---|---|---|---|---|
| | | | | the present |
| Method | | MPC | LS | application |
| var = 0 | r_{d} (A) | 0.2417 | 0.0855 | 0.0523 |
| | r_{q} (A) | 0.1492 | 0.0576 | 0.0335 |
| var = 0.02 | r_{d} (A) | 0.2568 | 0.1068 | 0.0825 |
| | r_{q} (A) | 0.1660 | 0.0870 | 0.0737 |
| var = 0.05 | r_{d} (A) | 0.3018 | 0.3192 | 0.2883 |
| | r_{q} (A) | 0.2929 | 0.3139 | 0.2856 |

Specifically, under different noise levels, prediction residuals of the method of the present application for both indicators r_d(A) and r_q(A) are significantly smaller than those of conventional methods (MPC and LS), demonstrating higher prediction accuracy and robustness. Further, as data-driven methods, both the LS method and the method of the present application can accurately identify a current prediction model online, and both exhibit significant advantages over the model-based MPC method under a condition without additionally added noise (var=0) and under a low-noise condition (var=0.02). However, as the noise level increases (var=0.05), due to a negative influence of noise on the prediction model, prediction residuals of the LS method become greater than those of the MPC method, whereas the method of the present application can still maintain a significant advantage under the same conditions.

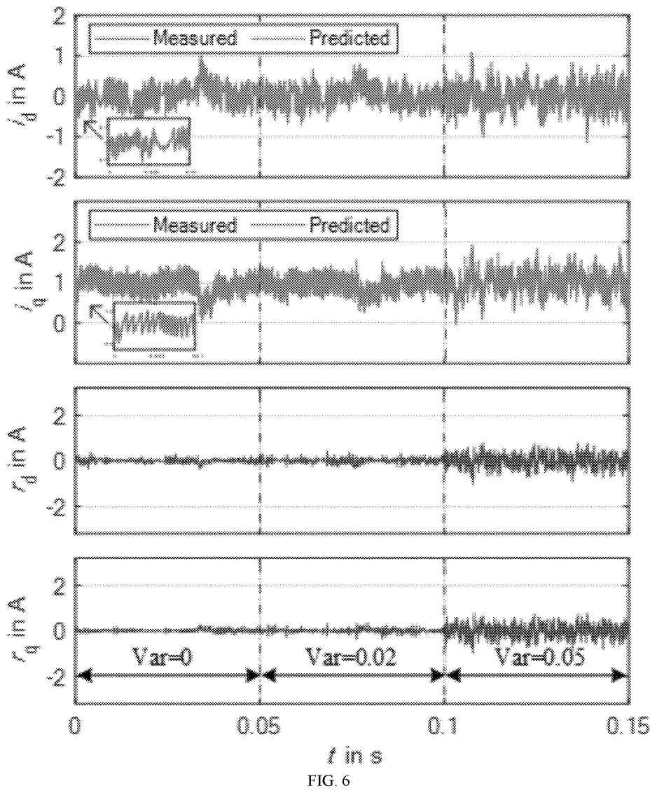

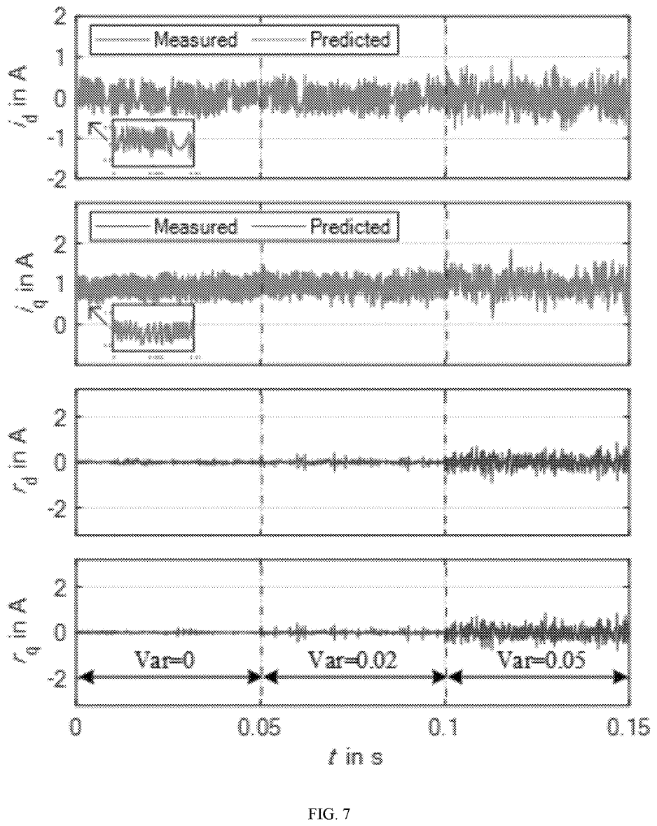

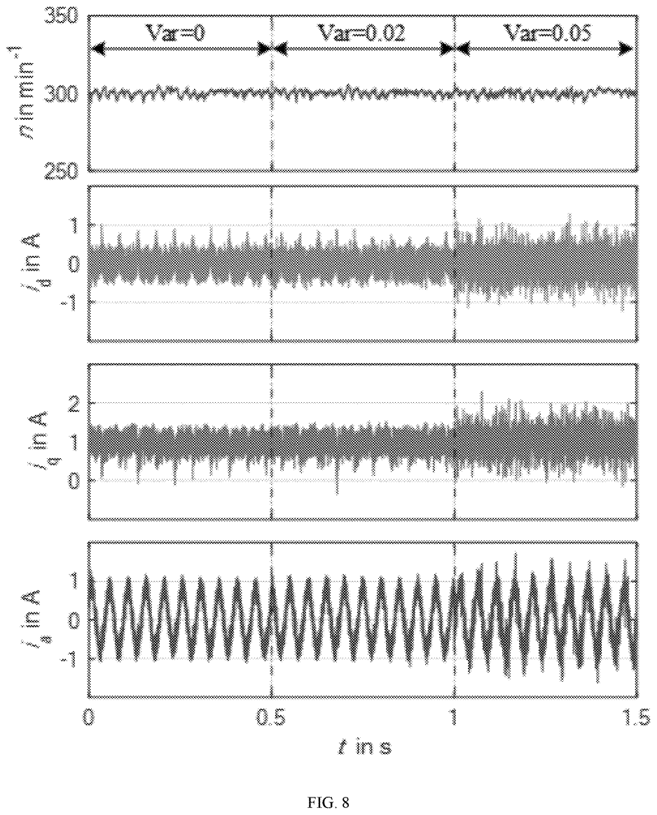

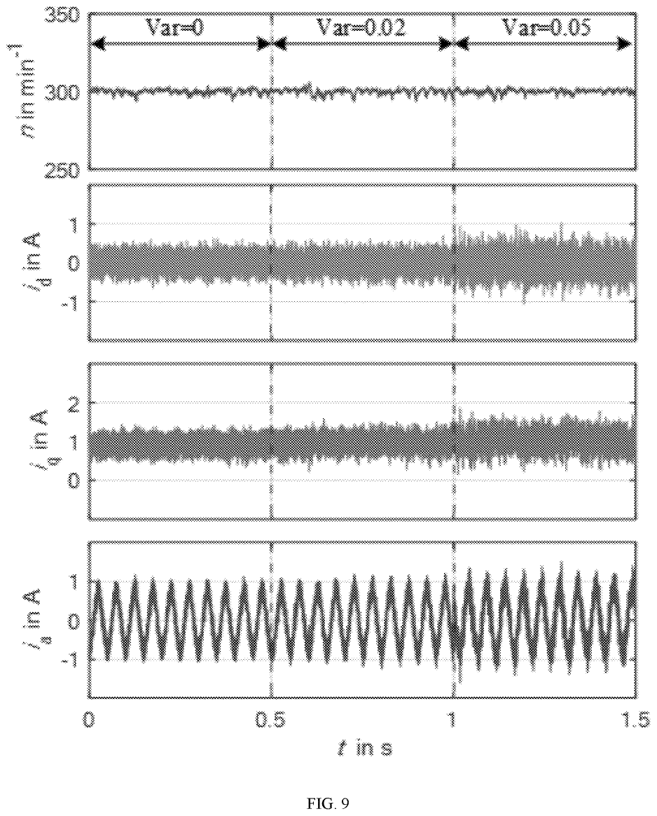

Referring to FIGS. 6-9, a comparison between least squares and the method provided in embodiments of the present application is shown. FIG. 6 is a schematic diagram showing a comparison of waveforms of d-q axis predicted currents, d-q axis actual currents, and d-q axis predicted current residuals based on least squares. FIG. 7 is a schematic diagram showing a comparison of waveforms of d-q axis predicted currents, d-q axis actual currents, and d-q axis predicted current residuals according to the data-driven predictive current modeling method for a permanent magnet synchronous motor provided in embodiments of the present application. FIG. 8 is a schematic diagram showing a comparison of waveforms of rotational speed, d-q axis actual currents, and phase-A current based on least squares. FIG. 9 is a schematic diagram showing a comparison of waveforms of rotational speed, d-q axis actual currents, and phase-A current according to the data-driven predictive current modeling method for a permanent magnet synchronous motor provided in embodiments of the present application. In the figures, Measured indicates actually measured data, and Predicted indicates predicted data. It can be seen from the comparison in the figures that, under operating conditions involving noise interference, the method of the present application exhibits better predictive current performance than conventional least-squares modeling, as reflected in reduced current ripple and improved robustness under predictive-current closed-loop control.

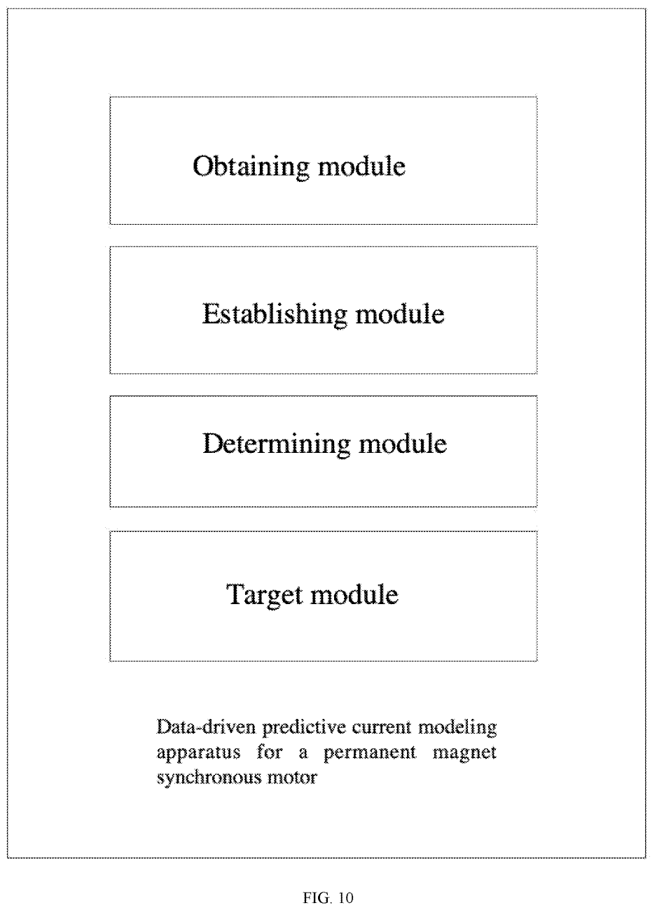

Referring to FIG. 10, based on the same inventive concept as in the foregoing embodiments, embodiments of the present application further provide a data-driven predictive current modeling apparatus for a permanent magnet synchronous motor, comprising:
an obtaining module configured to obtain, for a target motor, a data-driven current prediction model based on a cross-saturation effect, wherein the data-driven current prediction model comprises a parameter vector;
an establishing module configured to establish, based on historical data collected in historical control cycles, a ridge-regression-based calculation model of the parameter vector, wherein the calculation model comprises a penalty term;
a determining module configured to determine a target solution of the penalty term based on a noise severity of the historical data; and
a target module configured to obtain, based on the target solution, a target penalty term and a target parameter vector so as to establish a target data-driven current prediction model.

A person skilled in the art should understand that division of the modules in the embodiments is merely a division of logical functions. In practical application, all or part of the modules may be integrated into one or more physical carriers. In addition, these modules may all be implemented in software called by a processing unit, may all be implemented in hardware, or may be implemented in a combination of software and hardware. It should be noted that the modules in the data-driven predictive current modeling apparatus for a permanent magnet synchronous motor in this embodiment correspond one-to-one to the respective steps in the data-driven predictive current modeling method for a permanent magnet synchronous motor in the foregoing embodiments. Therefore, for specific implementation of this embodiment, reference may be made to implementation of the foregoing data-driven predictive current modeling method for a permanent magnet synchronous motor, and details are not repeated herein.

Based on the same inventive concept as in the foregoing embodiments, embodiments of the present application further provide a computer-readable storage medium storing a computer program, wherein, when the computer program is loaded and executed by a processor, the computer program implements the data-driven predictive current modeling method for a permanent magnet synchronous motor provided in embodiments of the present application.

Based on the same inventive concept as in the foregoing embodiments, embodiments of the present application further provide an electronic device, comprising a processor and a memory, wherein:
the memory is configured to store a computer program; and
the processor is configured to load and execute the computer program so that the electronic device performs the data-driven predictive current modeling method for a permanent magnet synchronous motor provided in embodiments of the present application.

In some embodiments, the computer-readable storage medium may be a memory such as FRAM, ROM, PROM, EPROM, EEPROM, flash memory, magnetic surface memory, optical disk, or CD-ROM, or may be various devices including one or any combination of the foregoing memories. The computer may be various computing devices including intelligent terminals and servers.

In some embodiments, executable instructions may take the form of a program, software, a software module, a script, or code, may be written in any form of programming language, including a compiled or interpreted language, or a declarative or procedural language, and may be deployed in any form, including being deployed as a standalone program or being deployed as a module, component, subroutine, or another unit suitable for use in a computing environment.

For example, the executable instructions may, but need not, correspond to a file in a file system, and may be stored in a portion of a file that stores other programs or data, for example, in one or more scripts stored in a HyperText Markup Language (HTML) document, in a single file dedicated to the program in question, or in multiple coordinated files, such as files storing one or more modules, subprograms, or portions of code.

For example, the executable instructions may be deployed for execution on one computing device, on multiple computing devices located at one site, or on multiple computing devices distributed across multiple sites and interconnected through a communication network.

It should be noted that, herein, the terms “comprise,” “include,” or any other variants thereof are intended to cover a non-exclusive inclusion, such that a process, method, article, or system comprising a series of elements includes not only those elements, but also other elements not expressly listed, or elements inherent to such process, method, article, or system. Without further limitation, an element defined by the phrase “comprising a/an . . . ” does not exclude the presence of another identical element in the process, method, article, or system that comprises the element.

The numbering of the embodiments of the present application is merely for description and does not indicate superiority or inferiority of the embodiments.

From the description of the above implementations, a person skilled in the art can clearly understand that the methods of the foregoing embodiments may be implemented by software in combination with a necessary general-purpose hardware platform, and of course may also be implemented by hardware, although in many cases the former is a better implementation. Based on such understanding, the technical solutions of the present application, in essence, or the part contributing to the prior art, may be embodied in the form of a software product. The computer software product is stored in a storage medium, such as a read-only memory, a random access memory, a magnetic disk, or an optical disk, and includes a plurality of instructions for causing a multimedia terminal device, such as a mobile phone, a computer, a television receiver, or a network device, to perform the methods described in the embodiments of the present application.

In summary, the present application provides a data-driven predictive current modeling method, apparatus, medium, and device for a permanent magnet synchronous motor. The method comprises: obtaining, for a target motor, a data-driven current prediction model based on a cross-saturation effect, wherein the data-driven current prediction model comprises a parameter vector; establishing, based on historical data collected in historical control cycles, a ridge-regression-based calculation model of the parameter vector, wherein the calculation model comprises a penalty term; determining a target solution of the penalty term based on a noise severity of the historical data; and obtaining, based on the target solution, a target penalty term and a target parameter vector so as to establish a target data-driven current prediction model. In the present application, a data-driven current prediction model of a motor is first obtained in consideration of an influence of a cross-saturation effect on electromagnetics under actual conditions. Then, a ridge-regression-based calculation model of a parameter vector in the model is constructed based on historical data. Further, by evaluating a severity of noise in the data, dynamic adjustment of a ridge parameter is established to achieve adaptive penalization of the data noise, a target solution of a penalty term is determined, and the parameter vector is further back-calculated to obtain a final prediction model, thereby improving current prediction accuracy under noisy operating conditions.

The foregoing descriptions are merely preferred embodiments of the present application and are not intended to limit the present application. Any modifications, equivalent substitutions, improvements, and the like made within the spirit and principles of the present application shall fall within the scope of protection of the present application.

1. A data-driven predictive current modeling method for a permanent magnet synchronous motor, comprising:
obtaining, for a target motor, a data-driven current prediction model based on a cross-saturation effect, wherein the data-driven current prediction model comprises a parameter vector;
establishing, based on historical data collected in historical control cycles, a ridge-regression-based calculation model of the parameter vector, wherein the calculation model comprises a penalty term;
determining, based on a noise severity of the historical data, a target solution of the penalty term, wherein, before determining, based on the noise severity of the historical data, the target solution of the penalty term, the method further comprises:
respectively constructing matrices from data in the historical data corresponding to input data and output data;
obtaining a sum of squared residuals and a total sum of squares based on the matrices; and
obtaining multicollinearity of the input data based on the sum of squared residuals and the total sum of squares so as to characterize the noise severity of the historical data,
wherein determining the target solution of the penalty term based on the noise severity of the historical data comprises:
obtaining, based on a positive correlation relationship between the multicollinearity and the noise severity of the historical data, a relationship between the multicollinearity and the penalty term; and
mapping, based on a mapping function, the relationship between the multicollinearity and the penalty term, and determining the target solution of the penalty term; and
obtaining, based on the target solution, a target penalty term and a target parameter vector so as to establish a target data-driven current prediction model.

2. The data-driven predictive current modeling method for a permanent magnet synchronous motor of claim 1, wherein obtaining the multicollinearity of the input data based on the sum of squared residuals and the total sum of squares so as to characterize the noise severity of the historical data comprises:
obtaining, based on the sum of squared residuals and the total sum of squares, a variance inflation factor of the input data to measure the multicollinearity of the input data so as to characterize the noise severity of the historical data.

3. The data-driven predictive current modeling method for a permanent magnet synchronous motor of claim 1, wherein, before obtaining the data-driven current prediction model of the target motor based on the cross-saturation effect, the method further comprises:
obtaining the input data and the output data, respectively, based on a stator voltage and a stator current in current control of the target motor; and
establishing the data-driven current prediction model of the target motor based on the cross-saturation effect based on the input data, the output data, and the parameter vector.

4. The data-driven predictive current modeling method for a permanent magnet synchronous motor of claim 1, wherein establishing the ridge-regression-based calculation model of the parameter vector based on the historical data collected in the historical control cycles comprises:
obtaining historical input data and historical output data based on the historical data collected in the historical control cycles;
constructing, based on the historical input data and the historical output data, a past subset and a future subset, respectively; and
establishing the ridge-regression-based calculation model of the parameter vector based on the past subset and the future subset.

5. The data-driven predictive current modeling method for a permanent magnet synchronous motor of claim 4, wherein establishing the ridge-regression-based calculation model of the parameter vector based on the past subset and the future subset comprises:
estimating the parameter vector based on the past subset and the future subset by using a least-squares solution so as to establish the ridge-regression-based calculation model of the parameter vector.

6. A data-driven predictive current modeling apparatus for a permanent magnet synchronous motor, comprising:
an obtaining module configured to obtain a data-driven current prediction model of a target motor based on a cross-saturation effect, wherein the data-driven current prediction model comprises a parameter vector;
an establishing module configured to establish, based on historical data collected in historical control cycles, a ridge-regression-based calculation model of the parameter vector, wherein the calculation model comprises a penalty term;
a determining module configured to determine, based on a noise severity of the historical data, a target solution of the penalty term, wherein, before determining the target solution of the penalty term based on the noise severity of the historical data, the apparatus is further configured to:
respectively construct matrices from data in the historical data corresponding to input data and output data;
obtain a sum of squared residuals and a total sum of squares according to the matrices; and
obtain multicollinearity of the input data based on the sum of squared residuals and the total sum of squares so as to characterize the noise severity of the historical data,
wherein the determining module is further configured to:
obtain, based on a positive correlation relationship between the multicollinearity and the noise severity of the historical data, a relationship between the multicollinearity and the penalty term; and
map, based on a mapping function, the relationship between the multicollinearity and the penalty term, and determine the target solution of the penalty term; and
a target module configured to obtain, based on the target solution, a target penalty term and a target parameter vector so as to establish a target data-driven current prediction model.

7. An electronic device, comprising:
a processor; and
a memory configured to store a computer program,
wherein the processor is configured to load and execute the computer program so that the electronic device performs the method of claim 1.
